(19) United States
(12) Patent Application Publication
(10) Pub. No.: US 2011/0293481 A1
(43) Pub. Date: Dec. 1, 2011

(54) Chemical Dissolution System

(76) Inventors: Chris B. Eanes, Arlington, TX (US); Pat D. Guccione, Keller, TX (US); Danielle C. Guccione, Olean, NY (US)

(21) Appl. No.: 12/787,025

(22) Filed: May 25, 2010

(51) Int. Cl. B01J 19/00

(52) U.S. Cl. 422/106; 422/261; 422/278

(57) ABSTRACT

A system for dissolving solid chemicals in an aqueous liquid, the system including a hopper that holds a plurality of stacked solid blocks containing water treatment chemicals for use in industrial and process applications, a liquid flow control system that delivers a selectively controlled flow of pressurized aqueous liquid to sprayer outlets that cause the pressurized liquid to impinge sequentially against the bottom surface of the bottom block in the stack, thereby successively dissolving each block, and a reservoir disposed beneath the stack that collects and holds the aqueous fluid containing the solubilized chemical from the blocks until it is discharged for subsequent use.

### BACKGROUND OF THE INVENTION

1. Field of the Invention

This invention relates to a system and apparatus useful for dissolving water treatment chemicals that are provided in the form of water-soluble, solid rectangular blocks or “bricks.” The chemical-containing blocks can be stacked in a hopper and are dissolved sequentially by controlled sprays of water that are directed against the bricks disposed in the stack. The sprayed water, containing dissolved chemicals, can be recaptured by gravity flow and accumulated in a reservoir disposed in the base. The liquid level in the reservoir is controlled as desired, and the chemical-containing water is subsequently discharged for use in various applications for industrial and process water treatment.

2. Description of Related Art

Various systems and devices have previously been disclosed for use in dissolving and dispersing chemicals in aqueous liquids. It is commonly known, for example, that 3-inch diameter tablets containing stabilized chlorine can be utilized in swimming pool chlorinators, either in addition to or in place of granular or powdered chlorine-containing chemicals, to eradicate bacteria and other harmful microorganisms.

Similarly, other water treatment chemicals in solid form are presently used, for example, as scale or corrosion inhibitors, oxygen scavengers, pH adjustors, sludge conditioners, antifoamants, biocides, biodispersants, and the like, in industrial and process waters. Many such water treatment chemicals are specifically formulated for particular end use applications such as, for example, boilers, cooling towers, cooling water systems, wastewater and industrial effluents, and the like. Such chemicals have previously been provided as injectable liquids, as tablets or gels, or more recently, as 1-gallon bottles of solid concentrate.

Considerations that can be important when evaluating possible sources and delivery systems for water treatment chemicals used for industrial and process water treatment include factors such as the storage space required for chemicals awaiting use, the frequency with which new chemicals are added to the system and the ease of such addition, the level of monitoring that is required during each operational cycle, whether a particular system can reliably produce aqueous solutions having a substantially constant solution strength throughout each operational cycle, whether the dissolution rate can be easily and reliably adjusted if desired; and whether the system apparatus is relatively inexpensive to manufacture, install and maintain.

### SUMMARY OF THE INVENTION

A preferred solid chemical dissolution system of the invention desirably includes a chemical containment apparatus and a liquid flow control system. The chemical containment apparatus includes a base with a liquid reservoir and a chemical hopper that slidably engages the base. A plurality of solid blocks, each desirably comprising at least one water treatment chemical suitable for the intended use, are stacked inside the chemical hopper, where they are supported by a grid disposed above the liquid reservoir. The liquid flow control system supplies a controlled flow of aqueous liquid to sprayers disposed beneath the hopper. The sprayers are directed through the openings in the grid and against the bottom of a stack of solid chemical-containing blocks disposed inside the hopper. A controlled flow of aqueous liquid is sprayed into contact with a facing solid surface having a substantially fixed rectangular shape, thereby producing a relatively constant concentration of solubilized chemicals for a given inlet flow rate. Because the chemical containment apparatus can include a plurality of blocks that are stacked one above the other inside the device, and because each block of chemical is significantly larger than conventional prior art tablets, the service intervals needed for chemical replacement can be significantly longer than would otherwise be experienced.

The aqueous liquid that is sprayed against the bottom surface of the solid chemical block solubilizes a portion of the chemical(s) contained in the block and flows downwardly by gravity through the supporting grid and into the liquid reservoir of the chemical containment apparatus, where it is held pending discharge. The liquid reservoir desirably contains at least one liquid level sensor that is linked to a discharge valve that selectively controls a flow of aqueous liquid containing at least one solubilized chemical into another flow conduit to another process or system in which the chemically treated aqueous fluid is to be used. A discharge pump is optionally provided.

According to one embodiment of the invention, the inlet valve, one or more level sensors, the discharge valve and/or, if provided, the optional discharge pump, are all electronically linked to a programmable controller with timing circuitry and indicator lights. The programmable controller is preferably powered by direct current and is attachable via a step-down transformer and inverter to a conventional AC power source. The inlet valve and, optionally, the discharge valve, can be solenoid actuated. If desired, a chemical analyzer can also be linked to the controller to input data regarding the pH or chemical concentration of the chemical-containing aqueous liquid.

### BRIEF DESCRIPTION OF THE DRAWINGS

The apparatus of the invention is further described and explained in relation to the following drawings wherein:

FIG. 1 is a simplified exploded perspective view of a preferred embodiment of the chemical containment apparatus of the invention that includes without limitation a base unit, a hopper insertable into sliding engagement with the base unit, a support grid insertable into the hopper to support and maintain the chemical blocks, a plurality of chemical blocks, a cover, and an optional mounting bracket that can be used to secure the base unit to a wall or other support member;

FIG. 2 is a perspective view of the apparatus of FIG. 1, minus the optional mounting bracket, after it has been assembled to form the chemical containment apparatus of the invention;

FIG. 3 is a side elevation view of the chemical containment apparatus of the invention following installation of the liquid flow control system;

FIG. 4 is an enlarged detail view of the liquid flow control system of the invention substantially as shown in FIG. 3;

FIG. 5 is a front elevation view of the solid chemical dissolution system of FIG. 3;

FIG. 6 is a rear elevation view of the solid chemical dissolution system of FIG. 3;

FIG. 7 is a cross-sectional plan view, partially broken away, taken along line 7-7 of FIG. 5; and

FIG. 8 is a cross-sectional elevation view taken along line 8-8 of FIG. 3.

Like reference numerals are used to designate like parts in all figures of the drawings.

### DESCRIPTION OF THE PREFERRED EMBODIMENTS

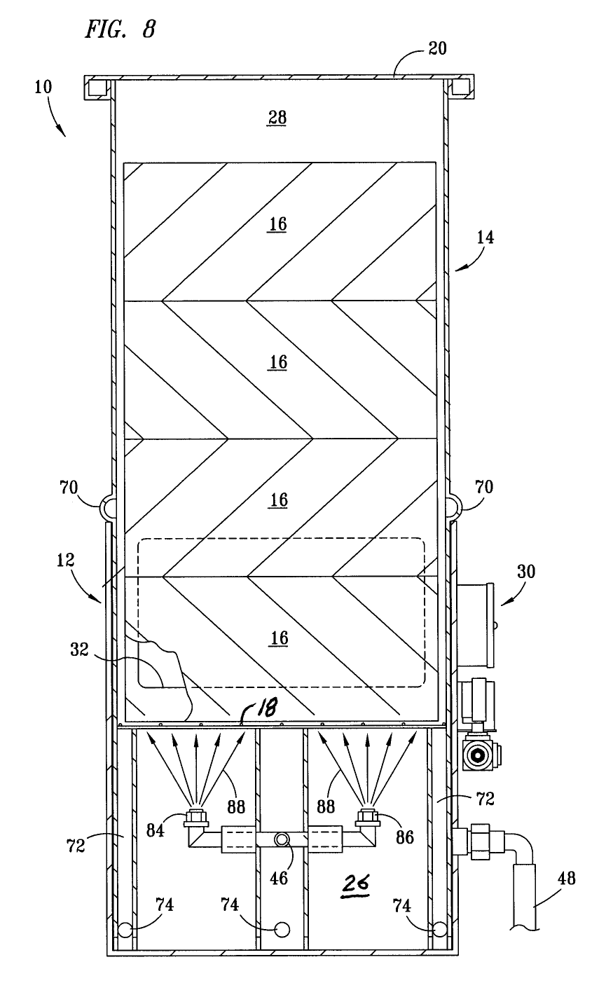

Referring to FIG. 1, a preferred embodiment of chemical dissolution system 10 of the invention includes a chemical containment system comprising base unit 12 with interior reservoir 26, chemical hopper 14 comprising interior cavity 28, a chemical block support grid 18 that is configured to rest inside interior cavity 28 on or near the top of support legs 72 of hopper 14, and removable cover 20 that is configured to releasably close the top of hopper 14 after a plurality of substantially rectangular, solid blocks 16 comprising chemical solids are stacked inside hopper 14. It should be understood that FIG. 1 is not drawn to scale and that the thicknesses of individual solid blocks 16 are reduced as shown in order to fit FIG. 1 on the page. A more accurate representation of the manner in which the stacked blocks 16 desirably fit inside hopper 14 is shown in FIG. 8, wherein it is seen that four stacked blocks substantially fill interior cavity 28 of hopper 14. Base unit 12, hopper 14 and cover 20 can be made of any suitable material but are preferably molded from a polymeric material that is resistant to degradation in the presence of whatever chemicals are present in blocks 16 or in the aqueous liquid that flows through system 10 during use.

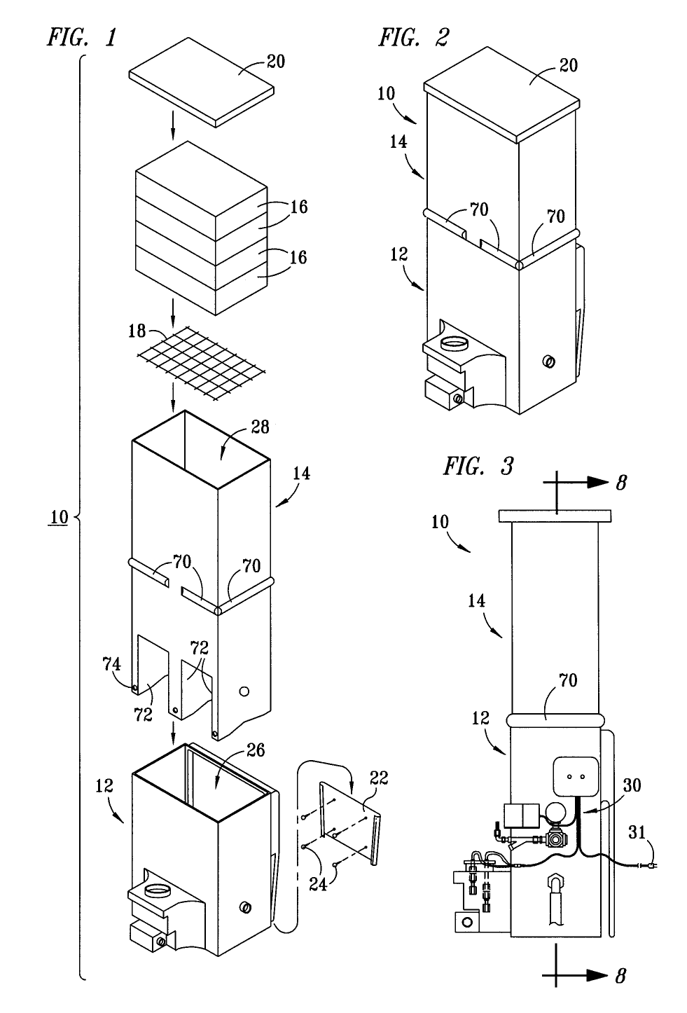

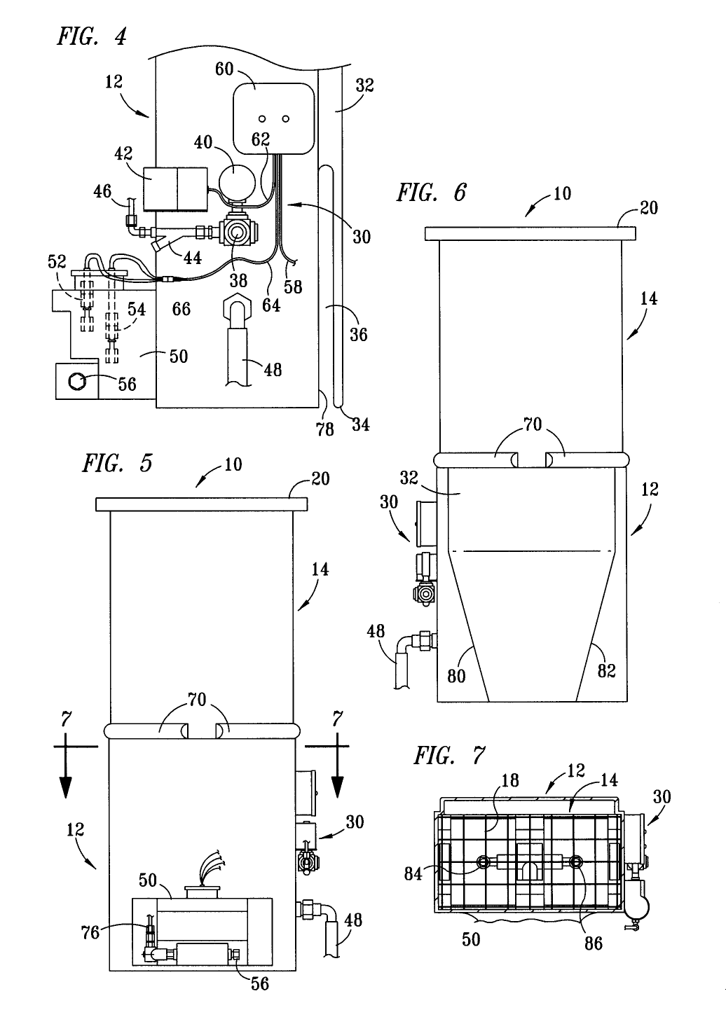

According to a preferred embodiment of the invention, the lower portion of hopper 14 is engageable, and most preferably slidably engageable, with interior reservoir 26 of base unit 12. When the bottom of hopper 14 is inserted downwardly into reservoir 26, the bottoms of legs 72 can rest on the bottom of base unit 12. Because hopper 14 is preferably unitarily molded and legs 72 are hollow, a drain hole 74 is provided in each leg to allow aqueous liquid sprayed upwardly through grid 18 to flow back into reservoir 26 if it drains downwardly through the legs during spraying at discussed in greater detail below. A wall mounting bracket 22 is optionally provided for use in securing chemical dissolution system 10 to a wall or other vertical support using conventional fasteners 24. As seen best in FIGS. 4 and 6, back side 78 of base unit 12 can comprise a mounting structure 32 having a tapered portion with tapered edges 82 and free end 34 that is spaced apart by gap 36 to permit free end 34 to be inserted downwardly into mounting bracket 22 so that tapered edges 82 are held by cooperative tapered sides of mounting bracket 22 (FIG. 1). FIG. 2 is a fully assembled view of the structures shown in FIG. 1, but with mounting bracket 22 omitted. It will be observed that when the lower portion of hopper 14 is seated inside base unit 12, outwardly projecting bosses 70 on the outside wall of hopper 14 rest against the top edges of base unit 12 to further distribute the load that would otherwise be directed through legs 72 of hopper 14 to the bottom wall of base unit 12. This can be more significant if, for example, base unit 12 is mounted to a wall rather than resting on an underlying support surface.

Referring to FIG. 3, chemical dissolution system 10 preferably further comprises a liquid flow control system 30 not shown in FIG. 1 or 2, but which is further described in relation to FIGS. 4-8 of the drawings. Referring first to FIG. 4, a preferred liquid flow control system 30 further comprises a liquid inlet 38 that is desirably connectable using conventional fittings to a source of pressurized aqueous liquid, most preferably a conduit supplying water at line pressure, although pressurized aqueous liquid can also be supplied using a pump (not shown) supplying liquid from a non-pressurized source, or by connecting inlet 38 to such other pressurized liquid source as may be available. Although it will be appreciated that the system and apparatus of the invention can be used, for example, to dissolve chemicals that are not water soluble in liquids that comprise solvents or the like in which such chemicals are soluble, a principal focus of the present invention is for use in solubilizing water soluble-chemicals into aqueous liquids. Pressure gauge 40 is provided for use in determining the pressure of the incoming liquid. If desired, a volumetric flow meter can also be provided in liquid inlet 38, but in most cases, the flow rate of the aqueous liquid supplied to chemical dissolution system 10 will be determined by a solenoid 42 connected to an inlet valve disposed in liquid inlet 38. Strainer 44 can be provided if desired for use in capturing sediments or solids that may be entrained in the inlet liquid.

Programmable electronic controller 60 connected to a DC power supply by line 58 is desirably provided for use in controlling the flow of inlet liquid. The flow can be controlled in response to the sensed pressure and in response to data received from one or more liquid level sensors 52, 54 disposed in sump 50 that is in fluid communication with reservoir 26 inside base unit 12. The use of both high and low liquid level sensors is preferred. An overflow drain 48 disposed just above the normal high liquid level position is provided for use where any component of system 10 fails with the inlet valve in an open position. Drain port 56 is provided for use in draining sump 50 and reservoir 26 if needed for cleanout.

Referring next to FIGS. 7 and 8, during normal operation of chemical dissolution system 10, a pressurized flow of aqueous liquid received through inlet 38 is delivered through conduit 46 to a manifold connected to the center bottom leg 72 of hopper 14, where it is distributed to a plurality of laterally spaced sprayer outlets 84, 86 to produce an upwardly directed pressurized spray of aqueous liquid that passes through relatively wide openings in grid 18 and impinges against the major downwardly facing surface of the lowermost block 16 that is resting directly on the grid at that time. As the liquid sprays against the underside of the bottom block in the stack, chemicals disposed in the block are solubilized in the liquid, which then flows by gravity back down into reservoir 26. During steady state operation, the liquid flow rate is maintained substantially constant, and liquid can be withdrawn from reservoir 26 through discharge valve 76 at substantially the same rate that liquid enters system 10 through inlet 38. Level switches 52, 54 and solenoid 42 controlling the inlet valve can be used to compensate for minor irregularities in flow rate and pressure.

As sprays 88 of aqueous liquid continue to impinge against the lowermost block 16, it gradually erodes, and as it does so, the blocks above it drop down gravitationally to a position where the next sequential block in the stack is contacted by the liquid spray. With chemical dissolution system 10 operating in this manner, it is not necessary for system 10 to be serviced again until such time as the uppermost block in the stack, preferably the fourth block, is sufficiently eroded that it cannot provide a substantially constant surface area against which sprays 88 can impinge. At that time system 10 can be reloaded by removing cover 20 and placing four new blocks inside interior cavity 28 of hopper 14. The additional space provided above the uppermost block in the stack permits four more complete blocks to be added without removing the block then being used in the bottom of hopper 14 and without risking letting the bottom block become so thin that it can fracture prior to refilling hopper 14.

Through use of chemical dissolution system 10 as disclosed herein, it is possible to provide longer service intervals and to provide a substantially constant rate of dissolution, thereby assuring a more constant concentration of chemical in the liquid that is collected in and discharged from base unit 12. This is believed to be primarily attributable to a substantially constant spray pattern impinging against a substantially constant contact area at substantially constant pressure that is achieved through use of chemical dissolution system 10 of the invention. Where blocks 16 each comprise about 11 pounds of chemical, it has been determined that each group of four blocks comprises about the same amount of chemical as a 30-gallon drum. The blocks can be provided in an easily removable plastic wrap that is inexpensive and does not require direct contact with the skin of the user.

Other alterations and modifications of the invention will likewise become apparent to those of ordinary skill in the art upon reading this specification in view of the accompanying drawings, and it is intended that the scope of the invention disclosed herein be limited only by the broadest interpretation of the appended claims to which the inventors are legally entitled.

We claim:

1. A chemical dissolution system useful for solubilizing chemical solids in an aqueous liquid, the system comprising:
a receptacle containing a plurality of blocks stacked one above the other, each block comprising at least one chemical that is soluble in the aqueous liquid;
at least one sprayer configured to direct a spray of the aqueous liquid upwardly against a downwardly facing major surface of the block most nearly adjacent to the sprayer to gradually erode the block and to sequentially erode the blocks stacked above it while dissolving the at least one chemical in the aqueous liquid; and
a reservoir disposed beneath the blocks to collect the aqueous liquid containing the dissolved at least one chemical.

2. The chemical dissolution system of claim 1 comprising substantially rectangular blocks.

3. The chemical dissolution system of claim 1 comprising four blocks.

4. The chemical dissolution system of claim 1 wherein each block weighs about 11 pounds.

5. The chemical dissolution system of claim 1 wherein each block comprises more than one chemical that is soluble in the aqueous liquid.

6. The chemical dissolutions system of claim 1 where the reservoir is disposed in a base unit.

7. The chemical dissolution system of claim 6 wherein the receptacle is a hopper that is engageable with the base unit.

8. The chemical dissolution system of claim 1 wherein the receptacle is a hopper.

9. The chemical dissolution system of claim 8 wherein the hopper has a removable cover.

10. The chemical dissolution system of claim 8 wherein the at least one sprayer is connected to the hopper.

11. The chemical dissolution system of claim 8 wherein the hopper comprises a grid that supports the blocks above the at least one sprayer.

12. The chemical dissolution system of claim 1 comprising two laterally spaced sprayers.

13. The chemical dissolution system of claim 11 wherein the grid does not substantially impede the spray of aqueous liquid against the downwardly facing major surface of the lowermost block.

14. The chemical dissolution system of claim 1, further comprising a flow control system for the aqueous liquid.

15. The chemical dissolution system of claim 1 wherein the receptacle and the reservoir are made of molded polymeric material.

16. The chemical dissolution system of claim 14 wherein the flow control system further comprises an inlet, an inlet valve selectively controlling a flow of pressurized aqueous liquid through the inlet, a conduit providing fluid communication from the inlet valve to the at least one sprayer outlet; an outlet; and a discharge valve selectively controlling a flow of liquid from the reservoir through the outlet.

17. The chemical dissolution system of claim 16 wherein the flow control system further comprises at least one liquid level sensor disposed inside the reservoir.

18. The chemical dissolution system of claim 17 wherein the flow control system comprises a high liquid level sensor and a low liquid level sensor.

19. The chemical dissolution system of claim 14 wherein the flow control system further comprises a programmable electronic controller that is electronically linked to a solenoid that operates the inlet valve.

20. The chemical dissolution system of claim 19 wherein the programmable electronic controller is electronically linked to at least one liquid level sensor disposed inside the reservoir.

21. The chemical dissolution system of claim 1 wherein the aqueous liquid is water.

22. The chemical dissolution system of claim 1 wherein the concentration of dissolved chemical in the aqueous liquid contained in the reservoir is controlled by the flow rate and pressure of aqueous liquid delivered to the sprayer outlet.

23. A chemical dissolution system useful for solubilizing chemical solids in an aqueous liquid, the system comprising:
a chemical containment apparatus and a liquid flow control system;
the chemical containment apparatus further comprising a base with a reservoir configured to collect aqueous liquid containing at least one solubilized chemical, and a chemical hopper that engages the base and is configured to receive and support a stack of solid chemical blocks on a grid disposed in spaced-apart relation above the reservoir; and
the liquid flow control system further comprising an inlet configured to receive a pressurized flow of aqueous liquid, an inlet valve configured to selectively control a pressurized flow of aqueous liquid through the inlet, at least one upwardly directed sprayer outlet disposed beneath the stack of chemical blocks so as to impinge sequentially against a downwardly facing major surface of each block as the blocks dissolve one-by-one and descend gravitationally inside the hopper, a conduit providing fluid communication from the inlet valve to the at least one sprayer outlet; an outlet, and a discharge valve configured to selectively control a flow of aqueous liquid containing solubilized chemical from the reservoir to the outlet.

24. The chemical dissolution system of claim 23 wherein the chemical blocks each comprise at least one soluble water treating chemical.

25. The chemical dissolution system of claim 23 wherein the chemical blocks are substantially rectangular.

26. The chemical dissolution system of claim 23 comprising four chemical blocks.

27. The chemical dissolution system of claim 26 wherein each chemical block weighs about 11 pounds.

28. The chemical dissolution system of claim 24 wherein each block comprises more than one chemical that is soluble in the aqueous liquid.

29. The chemical dissolutions system of claim 23 where the reservoir is disposed in a base unit.

30. The chemical dissolution system of claim 29 wherein the receptacle is a hopper that slidably engages the base unit.

31. The chemical dissolution system of claim 23 wherein the receptacle is a hopper.

32. The chemical dissolution system of claim 23 wherein the hopper has a removable cover.

33. The chemical dissolution system of claim 23 wherein the at least one sprayer outlet is connected to the hopper.

34. The chemical dissolution system of claim 23 wherein the hopper comprises a grid that supports the blocks above the at least one sprayer outlet.

35. The chemical dissolution system of claim 23 comprising two laterally spaced sprayer outlets.

36. The chemical dissolution system of claim 34 wherein the grid does not substantially impede the spray of aqueous liquid against an adjacent block of chemical solids.

37. The chemical dissolution system of claim 23 wherein the reservoir and hopper are made of molded polymeric material.

38. The chemical dissolution system of claim 23 wherein the liquid flow control system further comprises at least one liquid level sensor disposed inside the reservoir.

39. The chemical dissolution system of claim 38 wherein the liquid flow control system comprises a high liquid level sensor and a low liquid level sensor.

40. The chemical dissolution system of claim 23 wherein the liquid flow control system further comprises a programmable electronic controller that is electronically linked to a solenoid that operates the inlet valve.

41. The chemical dissolution system of claim 40 wherein the programmable electronic controller is electronically linked to at least one liquid level sensor disposed inside the reservoir.

42. The chemical dissolution system of claim 23 wherein the aqueous liquid is water.

43. The chemical dissolution system of claim 23 wherein the concentration of dissolved chemical in the aqueous liquid contained in the reservoir is controlled by the flow rate and pressure of aqueous liquid delivered to the sprayer outlet.
